(19) United States
(12) Patent Application Publication
(10) Pub. No.: US 2016/0189059 A1
(43) Pub. Date: Jun. 30, 2016

(54) FEATURE TRANSFORMATION LEARNING DEVICE, FEATURE TRANSFORMATION LEARNING METHOD, AND PROGRAM STORAGE MEDIUM

(71) Applicant: NEC CORPORATION, Minato-ku, Tokyo (JP)

(72) Inventor: Masato ISHII, Tokyo (JP)

(21) Appl. No.: 14/909,883

(22) PCT Filed: Jul. 25, 2014
(86) PCT No.: PCT/JP2014/003923

§ 371 Date: Feb. 3, 2016

(30) Foreign Application Priority Data
Aug. 22, 2013 (JP) 2013-171876

(51) Int. Cl. G06N 99/00; G06F 9/48

(52) U.S. Cl. CPC G06N 99/005; G06F 9/4881

(57) ABSTRACT

A feature transformation learning device includes an approximation unit, a loss calculation unit, an approximation control unit, and a loss control unit. The approximation unit takes a feature value that is extracted from a sample pattern and then weighted by a training parameter, assigns that weighted feature value to a variable of a continuous approximation function approximating a step function, and, by doing so, computes an approximated feature value. The loss calculation unit calculates a loss with respect to the task on the basis of the approximated feature value. The approximation control unit controls an approximation precision of the approximation function with respect to the step function such that the approximation function used with the approximation unit approaches the step function according to a decrease in the loss. The loss control unit updates the training parameter such that the loss decreases.

### TECHNICAL FIELD

The present invention relates to a technology of machine learning relevant to a process to transform a feature extracted from a pattern into a low-dimensional feature.

### BACKGROUND ART

When a device (a computer) identifies, classifies, or verifies an image, a voice, a sentence, or the like, for example, the device extracts a feature from a pattern of the image, the voice, the sentence, or the like that is a processing object and performs (executes) the task of identification, classification, verification, or the like based on the feature. In order to reduce an amount of calculation of the device at the time of performing this task, a process (hereinafter, referred to as feature transformation) for transforming the feature extracted from the pattern into a low-dimensional feature may be performed. Because the feature transformation is a process for compressing the feature (reducing information amount (data amount)), when the device (computer) performs the task using the feature after feature transformation, a processing time required for the task and a memory capacity to be used can be reduced. In other words, when the device performs feature transformation, the device can perform the task (identification, classification, verification, or the like) at a high speed and with a small memory capacity.

In the feature transformation, for example, a matrix that projects the feature (feature vector) onto a low-dimensional subspace is used as a parameter. This parameter (projection matrix) is obtained by for example machine learning.

Here, an example of the feature transformation will be described simply. For example, the device (computer) projects the feature using the projection matrix (parameter) and then binarizes each element of the projected feature (feature vector). Specifically, for example, with respect to each element of the feature, the device gives “1” for positive values and “4” for negative values. When each element of the feature is represented by one of two values (for example, 1 or −1), that feature will be referred to as a binarized feature.

Because the binarized feature has only two values per one dimension, the amount of information is small and the calculation required for performing the task is simple. For this reason, when the binarized feature is used, the device can perform the process at the high speed and with the small memory capacity in comparison with a case in which the feature whose value is set from among three or more values of real numbers or integers is used.

In patent literature 1 and non-patent literature 1, a method for performing machine learning of a process to transform the feature into the binarized feature is disclosed. In non-patent literature 2, a method for performing machine learning of the feature transformation that is specialized in a type of task is disclosed. Further, in patent literature 2, a method for performing machine learning of a process related in a neural network is disclosed. In patent literature 3, a method for performing machine learning of a process control is disclosed.

### CITATION LIST

### Patent Literature

[PTL 1] Japanese Patent Application Laid-Open No. 2012-181566
[PTL 2] Japanese Patent Application Laid-Open No. H08(1996)-202674
[PTL 3] Japanese Patent Application Laid-Open No. H10(1998)-254504

### Non Patent Literature

[NPL1] Y. Weiss, A. Torralba, and R. Fergus, “Spectral Hashing”, NIPS, 2008
[NPL2] M. Norouzi, D. J. Fleet, and R. Salakhutdinov, “Hamming Distance Metric Learning”, NIPS, 2012

### SUMMARY OF INVENTION

### Technical Problem

As described above, using the binarized feature, the process can be performed at the high speed and the memory capacity of the device can be reduced. However, because each element of the feature has a discrete value, it is difficult to obtain an optimal solution when machine learning of the projection matrix (parameter) used in the feature transformation is performed.

In the method of machine learning disclosed in the patent literature 1 or the non-patent literature 1, the feature transformation is learnt so as to keep a distance relationship in a feature space before the feature transformation even after performing the feature transformation. For this reason, in some tasks, a case in which high accuracy cannot be obtained even when the feature obtained by the feature transformation based on the machine learning thereof is used occurs. Further, in the method disclosed in the non-patent literature 2, because an object function used when the machine learning of the feature transformation is performed is limited to a special type of function, the object function commonly used when the machine learning of the feature transformation is performed cannot be used without change. For this reason, the method disclosed in the non-cited literature 2 has a defect in which a flexibility of the machine learning is low.

The present invention is invented to solve the above-mentioned problem. Namely, a main object of the present invention is to provide a technology in which with respect to the machine learning of the parameter (projection matrix) used for the feature transformation in which the feature is transformed into the binarized feature, the parameter by which the accuracy of the task can be increased can be obtained and the machine learning with high flexibility can be realized.

### Solution to Problem

To achieve the main object of the present invention, a feature transformation learning device related in the present invention includes

an approximation unit that calculates an approximate feature by substituting a weighted feature in a variable of an approximation function that is continuous and approximates a step function, the weighted feature being a feature that is extracted from a sample pattern and is weighted by a learning object parameter;

a loss calculation unit that calculates a loss to a task based on the approximate feature;

an approximation control unit that controls approximation accuracy of the approximation function to the step function in such a way that the approximation function used in the approximation unit becomes closer to the step function with a decrease in the loss; and

a loss control unit that updates the learning object parameter so as to decrease the loss.

A feature transformation learning method related in the present invention includes:

calculating an approximate feature by substituting a weighted feature in a variable of an approximation function that is continuous and approximates a step function, the weighted feature being a feature that is extracted from a sample pattern and is weighted by a learning object parameter;

calculating a loss to a task based on the approximate feature;

controlling approximation accuracy of the approximation function to the step function in such a way that the approximation function becomes closer to the step function with a decrease in the loss; and

updating the learning object parameter so as to decrease the loss.

A program storage medium related in the present invention that stores a computer program that causes a computer to perform a set of processes, the set of processes includes:

a process to calculate an approximate feature by substituting a weighted feature in a variable of an approximation function that is continuous and approximates a step function, the weighted feature being a feature that is extracted from a sample pattern and is weighted by a learning object parameter;

a process to calculate a loss to a task based on the approximate feature;

a process to control approximation accuracy of the approximation function to the step function in such a way that the approximation function becomes closer to the step function with a decrease in the loss; and

a process to update the learning object parameter so as to decrease the loss.

Further, the above-mentioned object of the present invention can be also achieved by the above-mentioned feature transformation learning method corresponding to the feature transformation learning device of the present invention. Further, the above-mentioned object of the present invention can also be achieved by the feature transformation learning device of the present invention, a computer program which realizes the feature transformation learning method by a computer, and a program storage medium storing the computer program.

### Advantageous Effects of Invention

Using the present invention, with respect to the machine learning of the parameter used for the feature transformation in which the feature is transformed into the binarized feature, the parameter by which the accuracy of the task can be increased can be obtained and the machine learning with high flexibility can be realized.

### BRIEF DESCRIPTION OF DRAWINGS

FIG. 1 is a block diagram simply showing a configuration of a feature transformation learning device according to a first exemplary embodiment of the present invention.

FIG. 2 is a block diagram simply showing a configuration of a feature transformation learning device according to a second exemplary embodiment of the present invention.

FIG. 3 is a graph showing an example of an approximation function approximating a step function.

FIG. 4 is a flowchart showing an example of operation of a feature transformation learning device according to a second exemplary embodiment.

### DESCRIPTION OF EMBODIMENTS

Exemplary embodiments of the present invention will be described below with reference to drawings.

### First Exemplary Embodiment

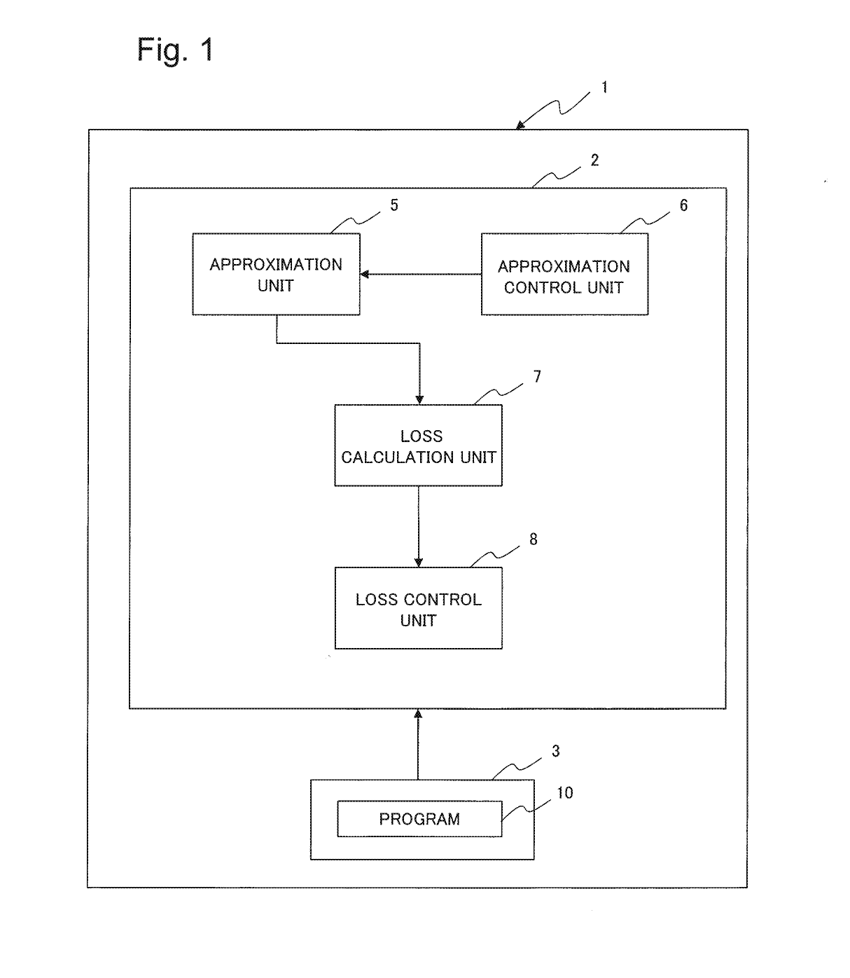

FIG. 1 is a block diagram simply showing a configuration of a feature transformation learning device according to a first exemplary embodiment of the present invention. This feature transformation learning device 1 according to the first exemplary embodiment includes a control device 2 and a storage device 3. The storage device 3 is a storage medium which stores various data and a computer program (program) 10. For example, the control device 2 includes a CPU (Central Processing Unit) and controls the entire operation of the feature transformation learning device 1 by executing the program 10 read from the storage device 3. In this first exemplary embodiment, the control device 2 can have a function related to machine learning based on the program 10. Namely, the program 10 can cause the control device 2 (in other words, the feature transformation learning device 1) to perform a following function.

That is, the control device 2 includes, as a functional unit, an approximation unit (approximation means) 5, an approximation control unit (approximation control means) 6, a loss calculation unit (loss calculation means) 7, and a loss control unit (loss control means) 8.

The approximation unit 5 has a function to calculate an approximate feature by substituting a weighted feature in a variable of a continuous approximation function approximated by a step function. The weighted feature is obtained by extracting a feature from a sample pattern (a pattern for learning) and weighting using a learning object parameter.

The loss calculation unit 7 has a function to calculate a loss to a task based on the approximate feature. Further, content of the task is determined in advance.

The approximation control unit 6 has a function to control an approximation accuracy of the approximation function to the step function in such a way that the approximation function used in the approximation unit 5 becomes closer to the step function with a decrease in the loss.

The loss control unit 8 has a function to update the parameter that is the learning object so as to decrease the loss.

When the feature transformation learning device 1 according to this first exemplary embodiment performs machine learning of the parameter used when the feature extracted from the pattern is transformed into the binarized feature, the feature transformation learning device 1 uses a continuous function (approximation function) without using a discontinuous function (step function). As a result, the feature transformation learning device 1 can avoid the inconvenience caused by the use of the discontinuous function. For example, when a loss function used in a process related to a loss in machine learning is based on the discontinuous function, it is difficult to optimize the loss function so that the loss calculated by the loss function is equal to a desired loss amount. In contrast, when the loss function is based on the continuous function, it is easy to optimize the loss function. For this reason, in the process related to the loss in the machine learning, the feature transformation learning device 1 can easily obtain the loss taking into consideration the expected task. As a result, the feature transformation learning device 1 can perform the machine learning of the parameter that is the learning object in a direction in which the accuracy of the task can be increased.

Further, in this feature transformation learning device 1, the approximation accuracy of the approximation function is increased with the decrease of the loss (in other words, with progress of the machine learning), so that the approximation function is close to the step function. Therefore, the approximation feature used for the machine learning is brought close to the binarized feature with the progress of the machine learning. As a result, in the feature transformation learning device 1, with the progress of the machine learning, the improvement of the accuracy of the task can be made fast.

Further, as described above, this feature transformation learning device 1 uses the continuous function (approximation function) without using the discontinuous function (step function). Therefore, the feature transformation learning device 1 does not need to use a specific object function and can perform the process at a high speed.

### Second Exemplary Embodiment

A second exemplary embodiment of the present invention will be described below.

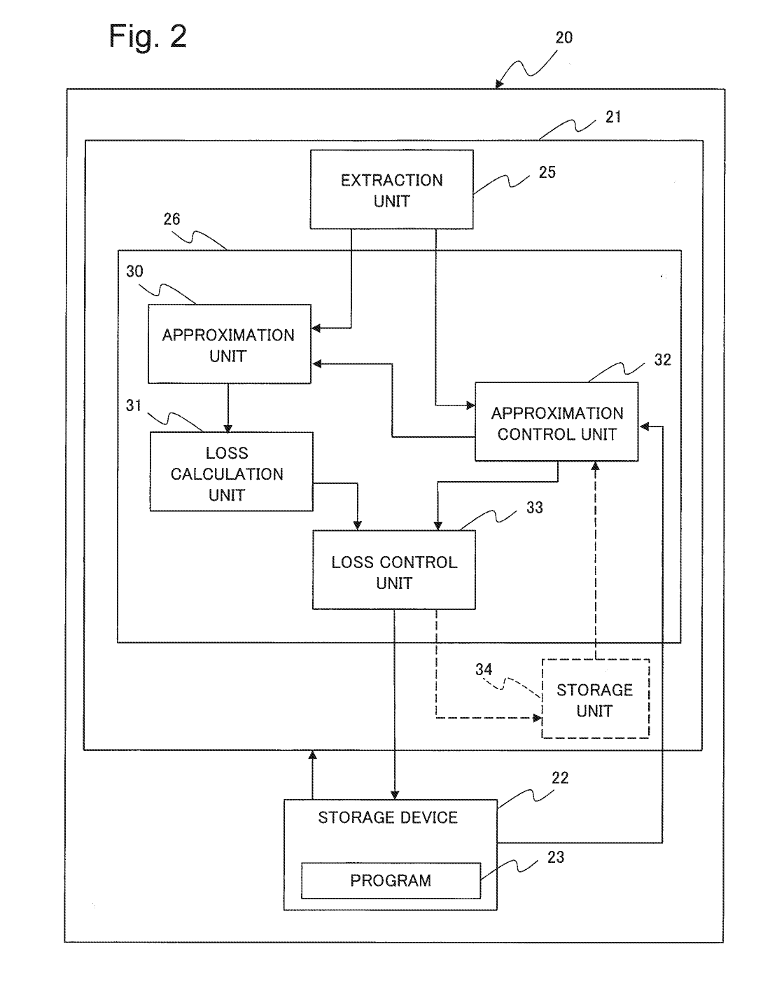

FIG. 2 is a block diagram simply showing a configuration of a feature transformation learning device according to the second exemplary embodiment. The feature transformation learning device 20 according to this second exemplary embodiment includes a control device 21 and a storage device 22 broadly. The storage device 22 is a storage medium. The storage device 22 stores a computer program (program) 23 which controls operation of the feature transformation learning device 20 and various data.

The control device 21 includes for example, a CPU (Central Processing Unit). The control device 21 reads the program 23 from the storage device 22, operates according to the program 23, and thereby can have various functions. In this second exemplary embodiment, the control device 21 includes, as a functional unit, an extraction unit (extraction means) 25 and a learning unit (learning means) 26.

The extraction unit 25 has a function to extract the feature from a pattern. In this second exemplary embodiment, in order to perform the machine learning of the parameter used for the feature transformation, a sample pattern (a pattern for learning) is given to the feature transformation learning device 20. The extraction unit 25 extracts the feature from the sample pattern. There are many methods for extracting the feature. The method can properly be determined considering content of the task and the pattern, and the like. Here, some methods are shown below as an example. For example, when the pattern is an image, a pixel value of the image is extracted as the feature. Further, a response value obtained by performing a filtering process of the image may be extracted as the feature. Further, in this second exemplary embodiment, the feature extracted by the extraction unit 25 may be represented by a feature vector x.

The learning unit 26 has a function to learn (perform the machine learning of) the parameter (projection matrix) used for the feature transformation based on the feature (feature vector x) extracted by the extraction unit 25. This learning unit 26 includes an approximation unit (approximation means) 30, a loss calculation unit (loss calculation means) 31, an approximation control unit (approximation control means) 32, and a loss control unit (loss control means) 33.

In this second exemplary embodiment, the parameter of the feature transformation that is an object of the machine learning is a parameter to which it is assumed that the feature after the feature transformation using the parameter is further transformed into the binarized feature. This parameter (hereinafter, this parameter is referred to as a parameter W) is stored in the storage device 22 or a storage unit 34 provided in the control device 21.

The approximation unit 30 has a function to calculate the following approximate feature based on the feature (feature vector x) extracted by the extraction unit 25, the parameter W, and a predetermined function. The approximate feature is the feature approximated the binarized feature.

By the way, assuming that the feature is transformed into the binarized feature by the feature transformation, it is conceivable that the binarized feature based on the extracted feature is calculated using the step function in the machine learning of the parameter W using the feature transformation. However, proceeding a process in which the machine learning of the parameter W is performed using the binarized feature, the device occurs, in a process for calculating the loss (described later), inconvenience due to the discontinuity of the value of each element of the binarized feature. Accordingly, in this second exemplary embodiment, the approximation unit 30 calculates the feature (approximate feature) approximated the binarized feature using the continuous function (approximation function) approximated the step function (discontinuous function). Namely, the approximation unit 30 weights the feature vector x using the parameter W and transforms the weighted feature vector (W*x) into the approximation function, so that the approximate feature is calculated. For example, a sigmoid function may be used as the approximation function. In this case, the approximate feature (vector) S is expressed by Equation (1) using the sigmoid function.

$$S ( W * x ) = \frac{2}{1 + {e}^{- W * x}} - 1 \qquad ( 1 )$$

In Equation (1), W represents the parameter of the feature transformation and x represents the feature vector extracted by the extraction unit 25. Further, in this description, a symbol “*” is a symbol of operation representing a matrix product. Further, in this description, Equation (1) shows that each element of the approximate feature (vector) S is composed of a function in which each element of which the feature vector (W*x) is an independent variable of the sigmoid function.

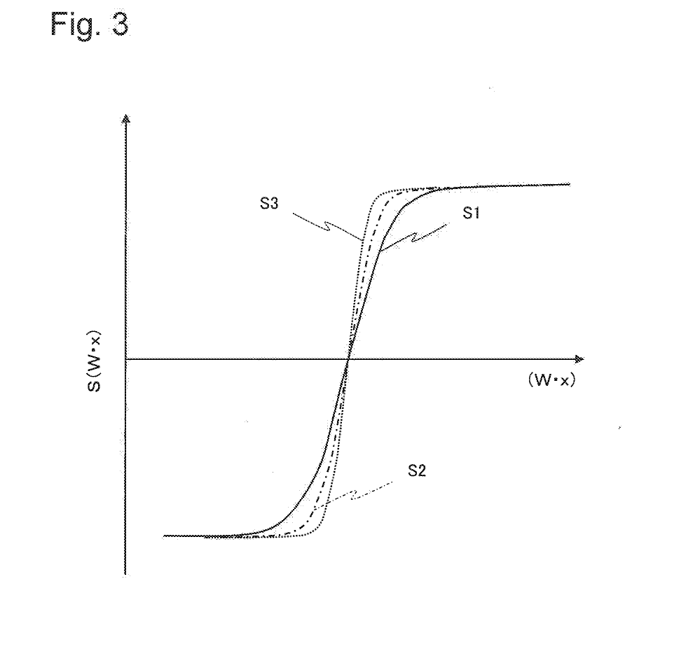

FIG. 3 is a graph showing one element of the approximate feature (vector) S expressed by Equation (1). In Equation (1), with the increase of an absolute value of “W*x”, the approximate feature S (in other words, the sigmoid function) changes from a curve S1 to a curve S2 and from the curve S2 to a curve S3 in FIG. 3 and is brought close to the step function. Namely, the approximation accuracy (in other words, the approximation accuracy of the approximate feature S to the binarized feature) of the approximation function to the step function changes according to the absolute value of the weighted feature vector (W*x). In addition, in the FIG. 3, although the variable (W*x) shown in Equation (1) is shown on the horizontal axis, each of the curves S1 to S3 shown in the FIG. 3 indicates the change of the approximate feature S when the feature vector x changes. The curves S1, S2, and S3 are different from each other because of the difference of the absolute value of W*x.

Further, the approximation function is not limited to the sigmoid function. It can be appropriately set.

The loss calculation unit 31 has a function to calculate the loss to the predetermined task based on the approximate feature S calculated by the approximation unit 30 and the loss function. The loss is a sum L_{(W*x)} of penalties given according to a low accuracy degree realized when the task is performed using the feature vector x. Here, because the loss is calculated using the approximate feature S, a loss L(S_{(W*x)}) calculated by the loss calculation unit 31 is an approximate value of a loss L(sign_{(W*x)}) based on the binarized feature.

L(S_{(W*x)})≅L(sign(W*x))

Further, any loss function can be used as the loss function used by the loss calculation unit 31 if it can calculate the loss to the predetermined task. The suitable loss function can be used.

The approximation control unit 32 has a function to control the approximation accuracy of the approximation function used by the approximation unit 30. Namely, when the loss is calculated using the loss function (hereinafter, may be referred to as a loss function Fₛ) based on the step function, the calculated loss is equal to the loss based on the binarized feature. However, because the loss function Fₛ is the discontinuous function, it is difficult to optimize the loss function Fₛ so that the loss is minimum.

Accordingly, as described above, the control device 21 (learning unit 26) according to this second exemplary embodiment uses the continuous function (for example, the sigmoid function) approximated the step function. As a result, because the loss function (hereinafter, may be referred to as a loss function Fₖ) based on the continuous approximation function is the continuous function, the control device 21 can easily optimize the loss function Fₖ using for example, a gradient method or the like, so that the loss is minimum.

When the approximation accuracy of the approximation function to the step function is low, the difference between the loss based on the loss function Fₖ using the approximation function and the loss based on the binarized feature is large. Therefore, even when the loss function Fₖ is optimized so that the loss is minimum, the loss based on the binarized feature is not sufficiently reduced. As a result, when the task is performed based on the binarized feature obtained using the parameter of the feature transformation that is obtained by performing the machine learning thereof by using the approximation function with low approximation accuracy, the accuracy of the task is low.

When such situation is taken into consideration, it is desirable that the approximation function is a function which can sufficiently approximate the step function at a high accuracy and whose shape is smooth at a certain level so that the loss can be easily minimized. For this reason, the approximation control unit 32 controls the approximation accuracy of the approximation function so that the approximation function is the desired function.

For example, as mentioned above, when the sigmoid function is used as the approximation function, the approximation accuracy of the approximation function (sigmoid function) to the step function varies according to the absolute value of the weighted feature vector (W*x). Therefore, the approximation control unit 32 receives the feature (feature vector x) extracted by the extraction unit 25 and controls the absolute value of the feature vector (W*x) obtained by weighting the feature vector x, so that the approximation accuracy of the approximation function is controlled. Specifically, for example, the approximation control unit 32 uses a regularization method. When regularization is used, for example, a regularization term R(W) shown in Equation (2) is used for the regularization term.

$$R ( w ) = \frac{1}{{‖ W ‖}_{F}^{2}} \qquad ( 2 )$$

Further, in Equation (2), W represents the parameter of the feature transformation.

As described above, this approximation control unit 32 controls the approximation accuracy of the approximation function and, the approximation unit 30 calculates the approximate feature using the approximation function having the controlled approximation accuracy.

The loss control unit 33 has a function to calculate the parameter W of the feature transformation which can reduce the loss based on the loss L(S_{(W*x)}) calculated by the loss calculation unit 31 and information related in the controlled approximation accuracy by the approximation control unit 32. Further, here, the parameter obtained by the loss control unit 33 is represented by “W*”.

In this second exemplary embodiment, the loss control unit 33 calculates the parameter W* of the feature transformation by optimizing (in this case, minimizing) the object function based on the loss and the approximation accuracy. Specifically, for example, when the approximation control unit 32 uses regularization, the object function P(W) can be expressed by the following Equation (3).

P(W)=L(S_{(W*x)})+λ*R(W) (3)

Further, in Equation (3), L(S_{(W*x)}) represents the loss and R(W) represents the regularization term. λ represents a parameter which determines the strength of the regularization term R(W).

The parameter W* of the feature transformation calculated by the loss control unit 33 can be represented by Equation (4).

W*=arg min P(W) (4)

Because the object function P(W) is the continuous function, the loss control unit 33 can calculate the parameter W* of the feature transformation by a method (for example, a conjugate gradient method) used for solving a general nonlinear optimization problem. The parameter W stored in the storage device 22 or the storage unit 34 is overwritten (updated) with the calculated parameter W*. Namely, whenever the parameter W* is obtained by the above-mentioned function of the learning unit 26 (functional units 30 to 33), the parameter W stored in the storage device 22 or the storage unit 34 is overwritten with the new parameter W. In other words, the machine learning of the parameter W of the feature transformation continues to be performed by the learning unit 26. When using the object function P(W), the loss control unit 33 calculates the parameter W by which the value of the regularization term R(W) can be made small. Namely, because the value of the regularization term R (W) gets smaller with the increase of the norm of the parameter W, the loss control unit 33 performs the machine learning of the parameter W so as to increase the norm of the parameter W. In other words, the loss control unit 33 performs the machine learning of the parameter W so as to increase the absolute value of the weighted feature vector (W*x). Namely, with the progress of the machine learning, the approximation accuracy of the approximation function is increased.

A binarized feature (feature vector) Z obtained by the feature transformation using the parameter W obtained by performing such the machine learning can be represented by Equation (5).

Z=sign(W*x) (5)

Here, “sign” represents a function (step function) that outputs a value (for example, 1 for positive, −1 for negative) indicating a sign of each dimension of the vector.

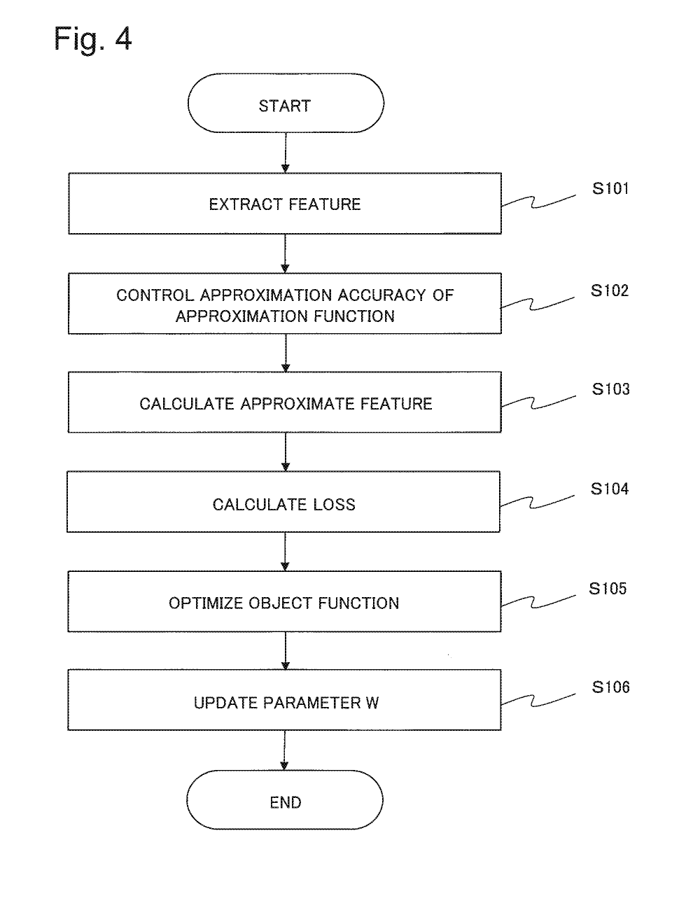

An example of operation of the machine learning in the feature transformation learning device 20 according to this second exemplary embodiment will be described below with reference to FIG. 4. Further, FIG. 4 is a flowchart illustrating a flow of operation of machine learning performed by the feature transformation learning device 20. This flowchart shows a processing procedure of a computer program executed by a control device 21 (CPU) in the feature transformation learning device 20.

For example, when a sample pattern (a pattern for learning) is inputted, the extraction unit 25 of the control device 21 extracts the feature from the sample pattern (Step S101). The approximation control unit 32 controls the approximation accuracy of the approximation function used in the approximation unit 30 by changing the absolute value of the feature vector (W*x) obtained by weighting the extracted feature (feature vector x) using the parameter W (Step S102). The approximation unit 30 calculates the approximate feature using the extracted feature (feature vector x) by the extraction unit 25 and the approximation function having the controlled approximation accuracy by the approximation control unit 32 (Step S103).

After the process of step 103, the loss calculation unit 31 calculates the loss to the predetermined task based on the calculated approximate feature (Step S104). Further, the loss control unit 33 optimizes the object function based on the loss calculated by the loss calculation unit 31 and the approximation accuracy controlled by the approximation control unit 32 (Step S105). Namely, the loss control unit 33 sets the parameter W* used in the approximation unit 30 so as to reduce the loss calculated by the loss calculation unit 31 under the control of the approximation control unit 32. The loss control unit 33 overwrites (updates) the parameter W stored in the storage device 22 or the storage unit 34 with the parameter W* (Step S106).

By repeating such operation, the machine learning of the parameter W is continued by the feature transformation learning device 20.

When this feature transformation learning device 20 performs the machine learning of the parameter W used for the calculation in which the feature is transformed into the binarized feature, the feature transformation learning device 20 uses the continuous approximation function approximated the step function. Namely, when using the feature extracted from the sample pattern as the approximate feature and performs feature transformation, the feature transformation learning device 20 uses the approximation function and performs the machine learning of the parameter W using the approximate feature obtained based on the approximation function. The accuracy of the task based on the binarized feature obtained using the parameter W of which such the machine learning is performed is high. Namely, the feature transformation learning device 20 can use an existing continuous loss function that can calculate the loss according to the task using the approximate feature. Further, the feature transformation learning device 20 performs the machine learning of the parameter W using the object function based on the loss function considering the content of the task and the approximation accuracy (in other words, the value according to the approximation accuracy of the approximate feature to the binarized feature) of the approximation function to the step function. For this reason, the feature transformation learning device 20 can obtain the parameter W by which the accuracy of the task can be increased.

Further, when using the above-mentioned approximate feature, the feature transformation learning device 20 can use the existing continuous loss function. Therefore, it is not necessary for the feature transformation learning device 20 to use the specific object function unlike a case of using a discontinuous loss function. As a result, using the feature transformation learning device 20, the optimization of the object function can be easily performed and whereby, a process for performing machine learning of the parameter W can be performed at a high speed.

### Third Exemplary Embodiment

A third exemplary embodiment according to the present invention will be described below. Further, the same reference numbers are used for the elements having the same function as the above-mentioned second exemplary embodiment and the description of the element will be omitted appropriately.

In this third exemplary embodiment, the approximation unit 30 of the learning unit 26 in the feature transformation learning device 20 calculates the approximate feature like the second exemplary embodiment. However, the approximation unit 30 uses a function based on the sigmoid function expressed by the following Equation (6) as the approximation function.

$$S ( W * x ) = \frac{2}{1 + {e}^{- α * ( W * x )}} - 1 \qquad ( 6 )$$

a in Equation (6) represents a parameter which controls the approximation accuracy of this approximation function. Here, when the absolute value of (W*x) is a fixed value, with the increase of the value of a, the approximation function is brought close to the step function.

The approximation control unit 32 has a function to control the approximation accuracy of the approximation function in which the value of a of the approximation function is increased while keeping the absolute value of the parameter W to the fixed value. For example, when the loss control unit 33 uses the gradient method as a solution method for optimizing the object function, the approximation control unit 32 increases the value of a by a fixed amount for each update of the solution as shown in Equation (7).

α_{new}=α+δ (7)

Further, δ shown in Equation (7) represents an update width that is set in advance and positive.

The feature transformation learning device 20 according to the third exemplary embodiment uses the approximate feature calculated using the approximation function approximated the step function and performs the machine learning of the parameter W of the feature transformation. Therefore, the feature transformation learning device 20 according to third exemplary embodiment has the same effect as that of the second exemplary embodiment.

### Other Exemplary Embodiments

Further, the present invention has been described above by using the first to third exemplary embodiments as an example. The present invention is not limited to the above mentioned first to third exemplary embodiments and may adapt to various embodiments. For example, although the feature transformation learning device 20 includes the extraction unit 25 in the second and third exemplary embodiments, for example, the feature transformation learning device 20 may not include the extraction unit 25 when the feature extracted from the sample pattern is provided from the outside.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-171876, filed on Aug. 22, 2013, the disclosure of which is incorporated herein in its entirety by reference.

### INDUSTRIAL APPLICABILITY

The present invention is effective in a field in which a device for performing a process of identifying, classifying, or verifying an image, a voice, a document, or the like is used.

### REFERENCE SIGNS LIST

1, 20 Feature transformation learning device
5, 30 Approximation unit
6, 32 Approximation control unit
7, 31 Loss calculation unit
8, 33 Loss control unit

What is claimed is:

1. A feature transformation learning device comprising:
an approximation unit that calculates an approximate feature by substituting a weighted feature in a variable of an approximation function that is continuous and approximates a step function, the weighted feature being a feature that is extracted from a sample pattern and is weighted by a learning object parameter;
a loss calculation unit that calculates a loss to a task based on the approximate feature;
an approximation control unit that controls approximation accuracy of the approximation function to the step function in such a way that the approximation function used in the approximation unit becomes closer to the step function with a decrease in the loss; and
a loss control unit that updates the learning object parameter so as to decrease the loss.

2. The feature transformation learning device according to claim 1, wherein the loss control unit calculates a parameter that minimizes an object function, and updates the learning object parameter with the parameter thus calculated, the object function being a function in which a value of a function whose value becomes smaller with an increase of an absolute value of the approximate feature is added to the loss.

3. The feature transformation learning device according to claim 1, wherein the approximation function includes, as an approximation accuracy parameter, the function that changes the approximation accuracy and
the approximation control unit controls the approximation accuracy of the approximation function by changing the approximation accuracy parameter in a direction in which the approximation accuracy increases with the update of the learning object parameter.

4. The feature transformation learning device according to claim 1, further comprising,
an extraction unit that extracts the feature from the sample pattern.

5. A feature transformation learning method, comprising:
calculating an approximate feature by substituting a weighted feature in a variable of an approximation function that is continuous and approximates a step function, the weighted feature being a feature that is extracted from a sample pattern and is weighted by a learning object parameter;
calculating a loss to a task based on the approximate feature;
controlling approximation accuracy of the approximation function to the step function in such a way that the approximation function becomes closer to the step function with a decrease in the loss; and
updating the learning object parameter so as to decrease the loss.

6. A non-transitory computer-readable recording medium storing a computer program that causes a computer to perform a set of processes, the set of processes comprising:
a process to calculate an approximate feature by substituting a weighted feature in a variable of an approximation function that is continuous and approximates a step function, the weighted feature being a feature that is extracted from a sample pattern and is weighted by a learning object parameter;
a process to calculate a loss to a task based on the approximate feature;
a process to control approximation accuracy of the approximation function to the step function in such a way that the approximation function becomes closer to the step function with a decrease in the loss; and
a process to update the learning object parameter so as to decrease the loss.

7. A feature transformation learning device comprising:
approximation means for calculating an approximate feature by substituting a weighted feature in a variable of an approximation function that is continuous and approximates a step function, the weighted feature being a feature that is extracted from a sample pattern and is weighted by a learning object parameter;
loss calculation means for calculating a loss to a task based on the approximate feature;
approximation control means for controlling approximation accuracy of the approximation function to the step function in such a way that the approximation function used in the approximation means becomes closer to the step function with a decrease in the loss; and
loss control means for updating the learning object parameter so as to decrease the loss.
